(19) United States
(12) Patent Application Publication
(10) Pub. No.: US 2024/0178719 A1
(43) Pub. Date: May 30, 2024

(54) MOTOR

(71) Applicant: TOYOTA JIDOSHA KABUSHIKI KAISHA, Toyota-shi (JP)

(72) Inventors: Yukio TSUCHIYA, Toyota-shi (JP); Hideyuki Higashi, Okazaki-shi (JP); Yasuhiro Makido, Toyota-shi (JP); Shogo Kajimoto, Toyota-shi (JP); Yuichiro Kanada, Toyota-shi (JP)

(73) Assignee: TOYOTA JIDOSHA KABUSHIKI KAISHA, Toyota-shi (JP)

(21) Appl. No.: 18/513,819

(22) Filed: Nov. 20, 2023

(30) Foreign Application Priority Data
Nov. 29, 2022 (JP) 2022-190646

(51) Int. Cl. H02K 5/20; H02K 1/16; H02K 3/32

(52) U.S. Cl. CPC H02K 5/20; H02K 1/16; H02K 3/32

(57) ABSTRACT

A motor may include a rotor; a stator comprising a stator core and a coil; a housing that houses the rotor and the stator; and a first annular member that provides a seal between a first end face of the stator core in an axial direction of the stator core and an inner wall surface of the housing. The first annular member may have a cylindrical shape about an axis of the stator core. The first annular member may include at least one first hole and at least one second hole through which refrigerant is injected toward a first coil end. The at least one first hole may be located on a first plane perpendicular to the axis. The at least one second hole may be located on a second plane that is perpendicular to the axis and spaced apart from the first plane in the axial direction.

### REFERENCE TO RELATED APPLICATION

This application claims priority to Japanese Patent Application No. 2022-190646 filed on Nov. 29, 2022. The entire content of the priority application is incorporated herein by reference.

### BACKGROUND ART

The technology disclosed herein relates to motors.

In a motor described in U.S. Pat. No. 11,125,315, a stator is housed in a housing. A plurality of injection holes is defined in an annular member that provides a seal between an axial end face of a stator core and an inner surface of the housing. Refrigerant is injected toward a coil end through each of the injection holes.

### DESCRIPTION

Heat distribution in a coil end may become widened or be intensified due to various factors such as the mounting position of a motor, the environment (inclination), etc. This means that a part of the coil end may not be appropriately cooled.

A motor disclosed herein may comprise a rotor; a stator comprising a stator core and a coil; a housing that houses the rotor and the stator; and a first annular member that provides a seal between a first end face of the stator core in an axial direction of the stator core and an inner wall surface of the housing. The first annular member may have a cylindrical shape about an axis of the stator core. The first annular member may comprise at least one first hole and at least one second hole through which refrigerant is injected toward a first coil end of the coil protruding from the first end face of the stator core. The at least one first hole may be located on a first plane perpendicular to the axis. The at least one second hole may be located on a second plane that is perpendicular to the axis and spaced apart from the first plane in the axial direction.

The refrigerant may comprise various types of refrigerants. For example, the refrigerant may be cooling oil. Alternatively, the refrigerant may be a liquid such as water or a gaseous fluid. According to the configuration above, the position of the at least one first hole in the axial direction is different from the position of the at least one second hole in the axial direction. By selecting either the at least one first hole or the at least one second hole, a refrigerant injection position can be adjusted along the axial direction. This allows a region over which the refrigerant is injected to be appropriately adjusted. Thus, the coil end can be appropriately cooled.

### BRIEF DESCRIPTION OF THE DRAWINGS

FIG. 1 is a schematic cross-sectional view of a motor 1.

FIG. 2 is a side view of a stator 20, etc.

FIG. 3A is a cross-sectional view along a first plane P1.

FIG. 3B is a cross-sectional view along a second plane P2.

FIG. 4 is a partially enlarged view of a cross section along a line IV-IV in FIG. 2.

FIG. 5 is a schematic cross-sectional view along a line V-V lying on a center plane CP in FIG. 1.

FIG. 6 is a schematic cross-sectional view of a motor 1.

FIG. 7A is a cross-sectional view along a first plane P1.

FIG. 7B is a cross-sectional view along a second plane P2.

FIG. 8A is a cross-sectional view along a first plane P1.

FIG. 8B is a cross-sectional view along a second plane P2.

FIG. 9 is a cross-sectional view along a second plane P2.

FIG. 10 is an enlarged view of a region at the same position as a region R10 in FIG. 1.

A distance from the second plane to the first end face of the stator core may be greater than a distance from the first plane to the first end face of the stator core. A number of the at least one first hole may be greater than a number of the at least one second hole. A coil density is greater in a part of the first coil end that is closer to the first end face than in a part of the first coil end that is farther from the first end face.

According to the configuration above, the number of the at least one first hole located closer to the first end face is greater than the number of the at least one second hole located farther from the first end face. Thus, the total amount of refrigerant injected from the at least one first hole can be made larger than the total amount of refrigerant injected from the at least one second hole. The part of the first coil end having a higher coil density can be appropriately cooled.

The at least one first hole may comprise a plurality of first holes disposed over an entirety of a circumference of the first annular member.

The configuration above allows the entire circumference of the first coil end to be cooled.

The at least one second hole may be disposed only in a first section of the circumference of the first annular member.

The configuration above allows a section of the first coil end that faces the first section of the first annular member to be intensively cooled by the refrigerant injected through the at least one second hole.

The first section of the circumference of the first annular member may be located below a horizontal plane passing through the axis.

A sufficient cooling effect may not be achieved for a part of the coil end that is located below the horizontal plane passing through the axis. This may occur, for example, when the refrigerant injected from a hole located below the horizontal plane has a larger injection velocity component in the opposite direction to the gravity direction as compared to the refrigerant injected from a hole located above the horizontal plane and/or when the temperature of refrigerant injected from a hole located below the horizontal plane is higher than the temperature of refrigerant injected from a hole located above the horizontal plane. According to the configuration above, the at least one second hole is disposed only in the first section located below the horizontal plane. Thus, the part located below the horizontal plane can be appropriately cooled.

The first section of the circumference of the first annular member may be located above a horizontal plane passing through the axis.

A sufficient cooling effect may not be achieved for a part of the coil end that is located above the horizontal plane passing through the axis. This may occur, for example, when the temperature of refrigerant injected from a hole located above the horizontal plane is higher than the temperature of refrigerant injected from a hole located below the horizontal plane. According to the configuration above, the at least one second hole is disposed only in the first section located above the horizontal plane. Thus, the par located above the horizontal plane can be appropriately cooled.

A distance from the second plane to the first end face of the stator core may be greater than a distance from the first plane to the first end face of the stator core. A number of the at least one first hole may be smaller than a number of the at least one second hole.

Cooling efficiency may be lower in a part of the first coil end farther from the first end face than in a part of the first coil end closer to the first end face. The configuration above allows the total amount of refrigerant injected from the at least one second hole located farther from the first end face to be increased as compared to the total amount of refrigerant injected from the at least one first hole located closer to the first end face. The part of the first coil end farther from the first end face can thus be appropriately cooled.

A distance from the second plane to the first end face of the stator core may be greater than a distance from the first plane to the first end face of the stator core. An opening area of the at least one first hole may be larger than an opening area of the at least one second hole.

The coil density is greater in a part of the first coil end closer to the first end face than in a part of the first coil end farther from the first end face. The configuration above allows an amount of refrigerant injected from each of the at least one first hole located closer to the first end face to be increased as compared to an amount of refrigerant injected from each of the at least one second hole located farther from the first end face. The part having a greater coil density can thus be appropriately cooled.

A distance from the second plane to the first end face of the stator core may be greater than a distance from the first plane to the first end face of the stator core. An opening area of the at least one first hole may be smaller than an opening area of the at least one second hole.

Cooling efficiency may be lower in a part of the first coil end farther from the first end face than in a part of the first coil end closer to the first end face. The configuration above allows an amount of refrigerant injected from each of the at least one second hole located farther from the first end face to be increased as compared to an amount of refrigerant injected from the at least one first hole located closer to the first end face. The part of the first coil farther from the first end face can thus be appropriately cooled.

Each of the at least one first hole may be located at a different position from any of the at least one second hole in a circumferential direction of the first annular member.

The configuration above allows a part of the coil end cooled by the refrigerant injected from each of the at least one first hole to be less likely to overlap a part of the coil end cooled by the refrigerant injected from each of the at least one second hole. The first coil end can thus be cooled over a broad area.

The at least one first hole may comprise a plurality of first holes. The at least one second hole may comprise a plurality of second holes. The first holes and the second holes may be arranged alternately along the circumferential direction of the first annular member.

The configuration above allows the first coil end to be cooled evenly over a broad area.

Each of the at least one second hole may be aligned with a corresponding one of the at least one first hole in a circumferential direction of the first annular member.

The configuration above allows the first coil end to be cooled over an axially broad area corresponding to the region where the at least one first hole and the at least one second hole are disposed.

An angle between an axis of each of the at least one second hole and the second plane may be different from an angle between an axis of each of the at least one first hole and the first plane.

In the configuration above, an injection direction of the refrigerant from each first hole is different from an injection direction of the refrigerant from each second hole. Thus, a part of the coil end cooled by the refrigerant injected from the at least one first hole and a part of the coil end cooled by the refrigerant injected from the at least one second hole can be set separately.

A distance from the second plane to the first end face of the stator core may be greater than a distance from the first plane to the first end face of the stator core. An axis of each of the at least one second hole may be inclined toward the first plane.

In the configuration above, an injection direction of the refrigerant injected from each second hole located farther from the first end face is directed toward the first end face. The first coil end can thus be appropriately cooled.

The coil may comprise a plurality of segment coils, and outer surfaces of the segment coils may be coated with insulating films. At the first coil end, ends of the plurality of segment coils may each be exposed from the insulating films. Each pair of segment coils may comprise a welded portion where the ends of the segment coils are welded to each other.

In the configuration above, the vicinity of the welded portion at which the ends of segment coils are welded can be more appropriately cooled.

The motor may further comprise a second annular member that provides a seal between a second end face of the stator core and the inner wall surface of the housing, the second end face being opposite to the first end face of the stator core in the axial direction. The second annular member may have a cylindrical shape about the axis of the stator core. The second annular member may comprise at least one third hole through which the refrigerant is injected toward a second coil end of the coil protruding from the second end face of the stator core. Each of the at least one third hole may be located on a third plane perpendicular to the axis.

The configuration above allows the first coil end including the welded portions to be more intensively cooled than the second coil end.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved motors.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### Embodiments

### First Embodiment

### Configuration of Motor 1

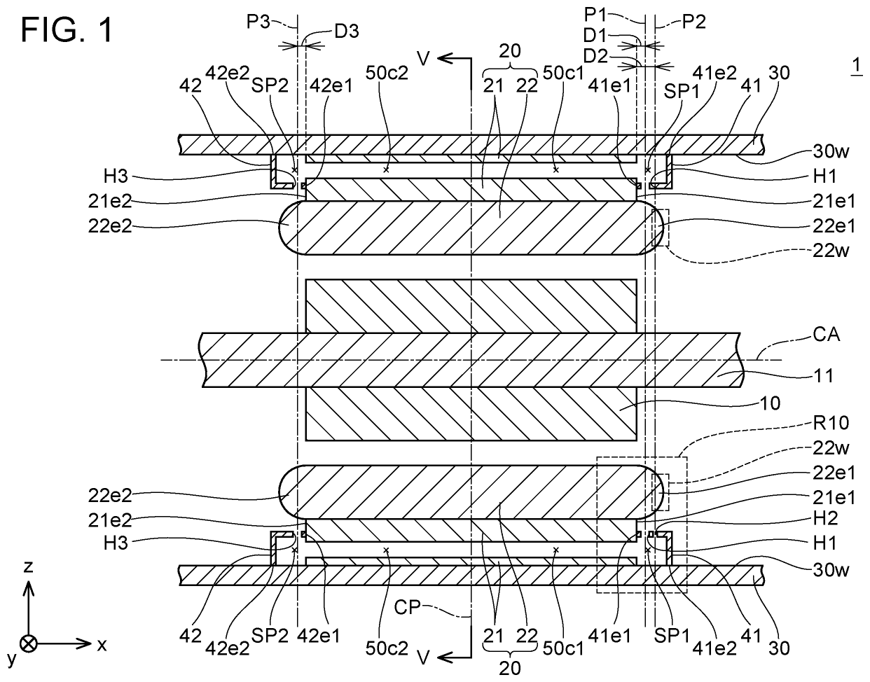

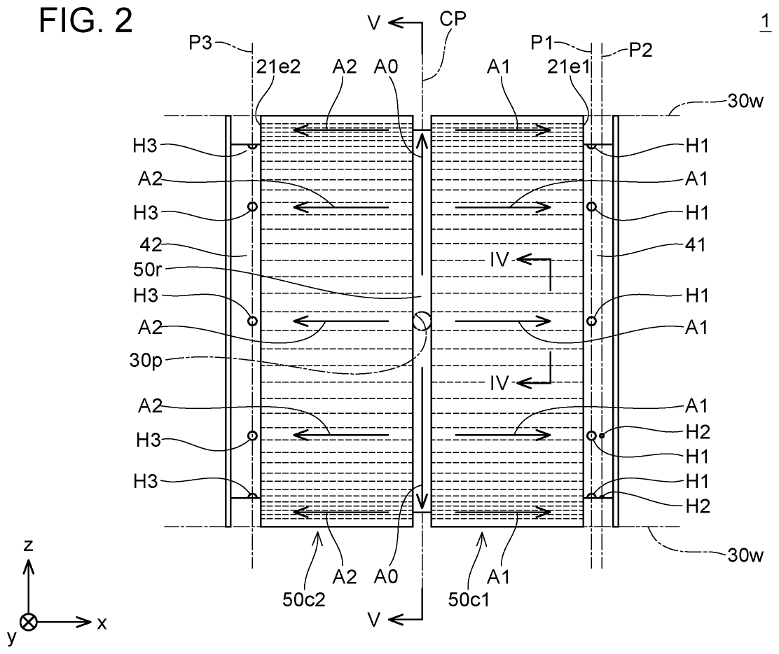

FIG. 1 shows a schematic cross-sectional view of a motor 1 according to an embodiment. FIG. 2 shows a side view of a stator 20, a first annular member 41, and a second annular member 42. In FIG. 2, depictions of a housing 30, a rotor 10, and a rotation shaft 11 are omitted for the sake of clarity, and an inner wall surface 30w and a supply port 30p of the housing 30 are represented by imaginary lines. In FIGS. 1 and 2, z-direction is a vertical direction, and x-direction and y-direction are horizontal directions. The x-direction is a direction in which the rotation shaft 11 extends. These directions also apply to the other drawings.

The motor 1 is mounted on an electric-powered vehicle. The electric-powered vehicle comprises a hybrid vehicle and an electric vehicle. In the electric-powered vehicle, the motor 1 may be used as a traction motor that generates power for the vehicle to travel, or as a generator that generates electric power from regenerative braking power and/or excess power of an engine. In the electric-powered vehicle, the motor 1 is mounted such that −z-direction is coincident with the gravity direction.

As shown in FIG. 1, the motor 1 comprises a center plane CP perpendicular to the rotation shaft 11. The center plane CP passes the center of a stator core 21 in its axial direction. The structure of the motor 1 is symmetric with respect to the center plane CP. Thus, hereinafter, the structure on +x-direction side relative to the center plane CP is mainly described.

The motor 1 mainly comprises the rotor 10, the stator 20, the housing 30, the first annular member 41, and the second annular member 42. The rotor 10 comprises the rotation shaft 11. The rotation shaft 11 is supported by the housing 30 via a bearing (not shown) and is rotatable. The rotor 10 is fixed to the rotation shaft 11.

The stator 20 comprises the stator core 21 and a coil 22. The stator core 21 is a substantially annular member formed, for example, of a stack of steel plates. The stator core 21 includes a first end face 21e1 at its one end in the axial direction (x-direction) and a second end face 21e2 at its other end in the axial direction. A wire that constitutes the coil 22 is wound around the stator core 21. A first coil end 22e1 of the coil 22 protrudes in the axial direction from the first end face 21e1. A second coil end 22e2 of the coil 22 protrudes in the axial direction from the second end face 21e2.

The coil 22 comprises a plurality of segment coils (not shown), outer surfaces of which are coated with insulating films. In the first coil end 22e1, ends of the respective segment coils are exposed from the insulating films and the ends of each pair of segment coils are welded with each other. Thus, welded portions 22w are formed in the first coil end 22e1. On the other hand, ends of the segment coils are not disposed in the second coil end 22e2. Further, in the second coil end 22e2, the segment coils are coated with the insulating films. Thus, there are no welded portions formed in the second coil end 22e2. That is, the first coil end 22e1 and the second coil end 22e2 have different configurations. Further, as will be described later, cooling oil is injected through first holes Hl and second holes H2 to the first coil end 22e1, while the cooling oil is injected only through third holes H3 to the second coil end 22e2. That is, cooling efficiency is higher for the first coil end 22e1 including the welded portions 22w than for the second coil end 22e2 where there are no welded portions. The vicinity of the welded portions 22w can thus be appropriately cooled.

The housing 30 is a member that houses the rotor 10 and the stator 20. The housing 30 surrounds the stator 20. A supply hole 30p, which will be described later, is defined in a side surface of the housing 30. A cooling oil reservoir (not shown) is disposed at a bottom portion of the housing 30. Known prior art can be applied for basic configuration of the housing 30, and thus its detailed description is omitted here.

The first annular member 41 has a ring shape about the rotation shaft 11. The first annular member 41 is constituted of resin. As shown in FIG. 1, a first end portion 41e1 of the first annular member 41 is connected to the first end face 21e1 of the stator core 21. A second end portion 41e2 of the first annular member 41 is connected to an inner wall surface 30w of the housing 30. In this way, the first annular member 41 provides a seal between the first end face 21e1 and the inner wall surface 30w. A variety of features that enhance the sealability (e.g., seal groove) may be applied to the connection between the first end portion 41e1 and the first end face 21e1 and between the second end portion 41e2 and the inner wall surface 30w. A space SP1 is defined between the first annular member 41 and the inner wall surface 30w. The space SP1 has a ring shape about the rotation shaft 11. The first annular member 41 surrounds the first coil end 22e1. In other words, the first annular member 41 faces the first coil end 22e1.

The first annular member 41 comprises a plurality of first holes H1 and a plurality of second holes H2. The cooling oil is injected through the first holes H1 and the second holes H2 toward the first coil end 22e1. Positions of the first holes H1 and the second holes H2 are described. The stator core 21 comprises a center axis CA. The center axis CA of the stator core 21 is coincident with the center axis of the rotation shaft 11. Here, a first plane P1 and a second plane P2 perpendicular to the center axis CA are defined. In FIG. 1, the first plane P1 and the second plane P2 are represented by dashed-and-dotted imaginary lines. The second plane P2 is spaced apart from the first plane P1 in an axial direction of the center axis CA (in x-direction). A distance D2 from the second plane P2 to the first end face 21e1 of the stator core 21 is greater than a distance D1 from the first plane P1 to the first end face 21e1. Each of the first holes H1 is located on the first plane P1. Each of the second holes H2 is located on the second plane P2.

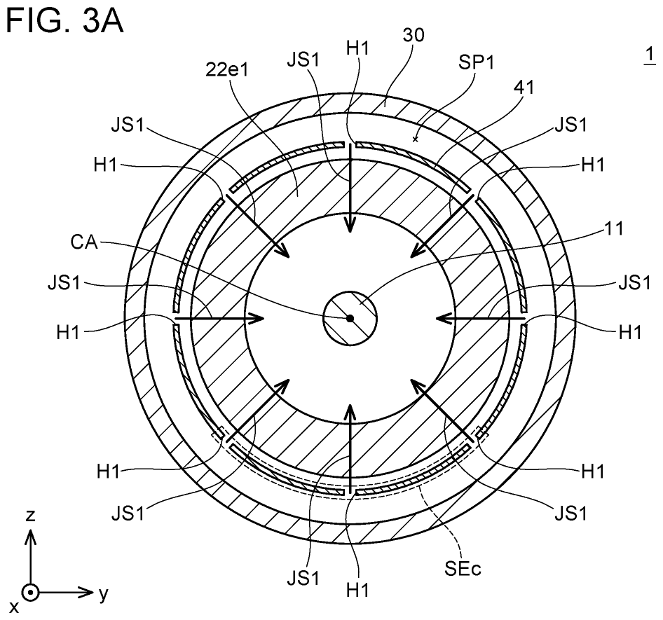

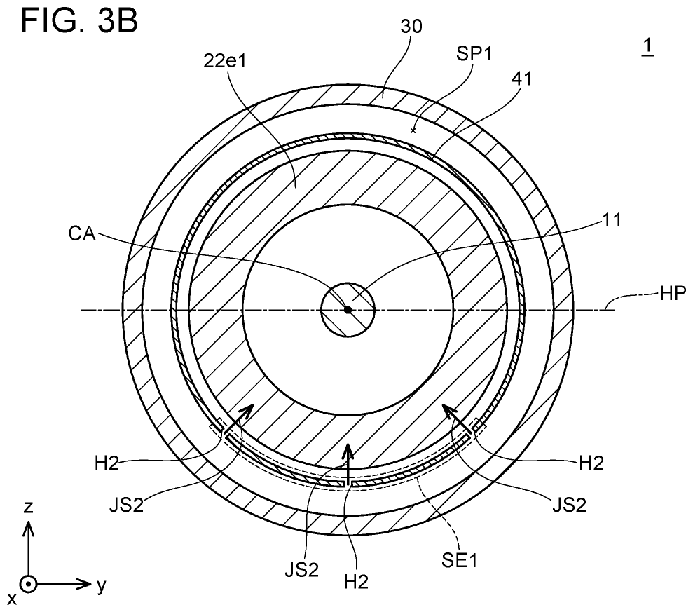

Referring to FIG. 3A, the plurality of first holes H1 is described. FIG. 3A shows a cross section along the first plane P1 that passes the centers of the first holes H1. The plurality of first holes H1 penetrates the first annular member 41 in its thickness direction. As shown in FIG. 3A, the first holes H1 are disposed over the entirety of a circumference of the first annular member 41. Thus, the first coil end 22e1 can be cooled over its entire circumference. In the present embodiment, eight first holes H1 are equally spaced on the circumference.

Referring to FIG. 3B, the plurality of second holes H2 is described. FIG. 3B shows a cross section along the second plane P2 that passes the centers of the second holes H2. The plurality of second holes H2 penetrates the first annular member 41 in its thickness direction. The plurality of second holes H2 is disposed only in a first section SE1 of the circumference of the first annular member 41. The first section SE1 is located below a horizontal plane HP passing the center axis CA. In the present embodiment, three second holes H2 are disposed in the first section SE1. The number of first holes H1 (eight) is larger than the number of second holes H2 (three).

Openings of the first holes H1 and the second holes H2 are circular. The first holes H1 all have the same first opening area. The second holes H2 all have the same second opening area. The first opening area is greater than the second opening area. That is, the diameter of the openings of the first holes H1 is greater than the diameter of the openings of the second holes H2. In FIGS. 3A and 3B, the diameters of the first holes H1 and the second holes H2 are shown larger than their actual diameters for the sake of clarity, and the diameter difference between the first holes H1 and the second holes H2 is shown emphasized.

Each of the three second holes H2 disposed in the first section SE1 is aligned with corresponding one of the first holes H1 in a circumferential direction of the first annular member 41. That is, the positions of the three second holes H2 disposed in the first section SE1 (FIG. 3B) on y-z plane are the same as the positions of three first holes H1 disposed in the corresponding section SEc (FIG. 3A) on y-z plane. This configuration allows the first coil end 22e1 to be cooled over an axially broad area corresponding to a region where these first holes H1 and second holes H2 are disposed.

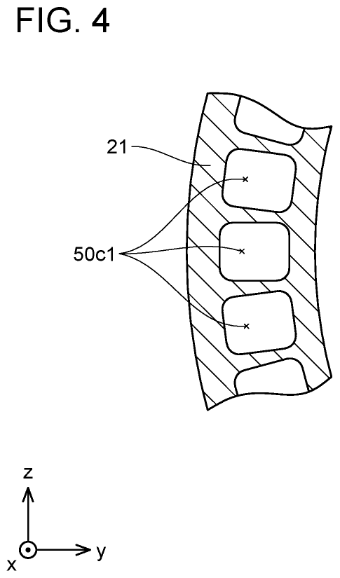

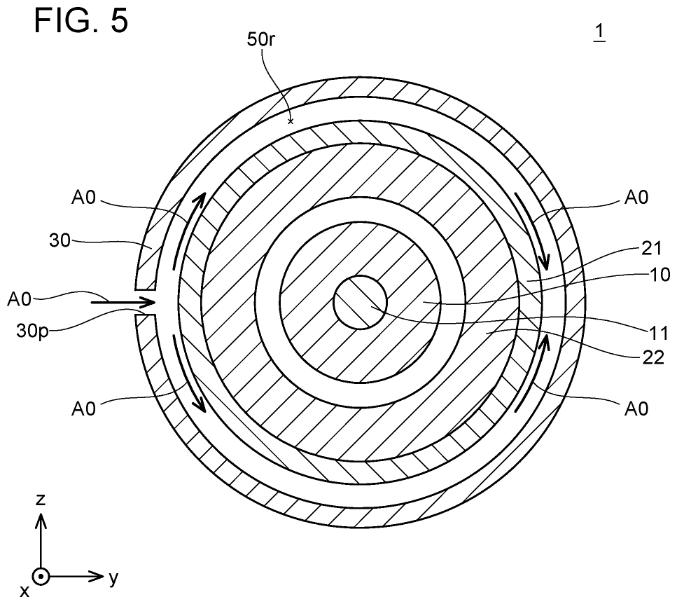

Referring to FIGS. 1, 2, 4, and 5, the stator core 21 is described. FIG. 4 shows a partially enlarged view of a cross section along a line IV-IV in FIG. 2. FIG. 5 shows a schematic cross-sectional view along a line V-V lying on the center plane CP in FIG. 1. The stator core 21 is a cylindrical member. As shown in FIG. 2, the stator core 21 comprises an annular channel 50r, first channels 50c1, and second channels 50c2.

As shown in FIG. 5, the annular channel 50r is a groove defined in the stator core 21 to extend over the entire circumference thereof. The annular channel 50r is open upward. This opening is covered by the inner wall surface 30w, which defines a flow path. The annular channel 50r is in communication with the supply port 30p of the housing 30.

As shown in FIGS. 2 and 4, the first channels 50c1 are tunnel-shaped flow paths defined in an outer circumferential surface of the stator core 21. In FIG. 2, the plurality of first channels 50c1 and the plurality of second channels 50c2 are represented by broken lines. The plurality of first channels 50c1 extends from the annular channel 50r up to the first end face 21e1, which is oriented in +x-direction. The first channels 50c1 extend parallel to each other and are equally spaced apart from each other in the circumferential direction. The plurality of second channels 50c2 has the same configuration as that of the plurality of first channels 50c1. The plurality of second channels 50c2 extends from the annular channel 50r up to the second end face 21e2, which is oriented in −x-direction.

The structure on +x-direction side relative to the center plane CP has been mainly described above. The structure on −x-direction side relative to the center plane CP is similar to that on +x-direction side. That is, there is a second annular member 42 that provides a seal between the second end face 21e2 of the stator core 21 and the inner wall surface 30w of the housing 30. A space SP2 is defined between the second annular member 42 and the inner wall surface 30w. The second annular member 42 comprises a plurality of third holes H3. The cooling oil is injected through the third holes H3 toward the second coil end 22e2. Here, a third plane P3 perpendicular to the center axis CA is defined. In FIG. 1, the third plane P3 is represented by a dashed-and-dotted imaginary line. A distance D3 from the third plane P3 to the second end face 21e2 of the stator core 21 is equal to the distance D1 from the first plane P1 to the first end face 21e1. Each of the third holes H3 is located on the third plane P3. Description for the number, opening area, and arrangement of the third holes H3 is omitted because they are the same as those of the first holes H1 described above. Further, other descriptions about the structure on −x-direction side relative to the center plane CP are also omitted herein.

### Operation

How the motor 1 operates is described. The cooling oil in the cooling oil reservoir flows through a pump and a supply pipe, which are not shown, and then flows into the supply port 30p of the housing 30. The cooling oil supplied through the supply port 30p flows into the annular channel 50r. This cooling oil flows within the annular channel 50r in the circumferential direction (see arrows AO in FIGS. 2 and 5). Then, the cooling oil flows into each of the plurality of first channels 50c1 and flows in +x-direction (see arrows A1 in FIG. 2). The cooling oil also flows into each of the plurality of second channels 50c2 and flows in −x-direction (see arrows A2 in FIG. 2). Once reaching +x-direction ends of the first channels 50c1, the cooling oil is discharged into the space SP1 and reaches the first annular member 41. Similarly, once reaching −x-direction ends of the second channels 50c2, the cooling oil is discharged into the space SP2 and reaches the second annular member 42.

Referring to FIGS. 3A and 3B, how the cooling oil is injected is described. Since the space SP1 is completely filled with the cooling oil, a pressure is applied to the cooling oil. As shown in FIGS. 3A and 3B, the cooling oil is injected through the first holes H1 and the second holes H2 toward the first coil end 22e1. In FIG. 3A, an amount of the cooling oil injected through each first hole H1 is represented by a vector JS1. In FIG. 3B, an amount of the cooling oil injected through each second hole H2 is represented by a vector JS2. Longer vectors indicate larger injection amounts. The opening area of the second holes H2 is 90% or less of the opening area of the first holes H1. Thus, the vectors JS1 for the first holes H1 can be made significantly larger than the vectors JS2 for the second holes H2.

### Effects

Heat distribution in the first coil end 22e1 may be widened or intensified in its variation due to various factors such as the mounting position of the motor 1, the environment (inclination), etc. This means that a part of the first coil end 22e1 may need locally intensive cooling. The technology according to the present embodiment allows for an adjustment of cooling oil injection positions in the axial direction by selecting at least one of the plurality of first holes H1 and the plurality of second holes H2. Thus, a region over which the cooling oil is injected can be appropriately adjusted by the relatively simple configuration of changing the hole positions. Since the cooling oil can be injected intensively to a part of the first coil end 22e1 that needs the intensive cooling, the first coil end 22e1 can be appropriately cooled.

The coil density of the first coil end 22e1 is higher in its part closer to the first end face 21e1 than in its part farther from the first end face 21e1. In the technology according to the present embodiment, the number of the first holes H1 located closer to the first end face 21e1 is greater than the number of the second holes H2 located farther from the first end face 21e1. Thus, the total amount of cooling oil injected from the first holes H1 is larger than the total amount of cooling oil injected from the second holes H2. Further, in the technology according to the present embodiment, the first opening area of the first holes H1 is larger than the second opening area of the second holes H2. Thus, an injection amount from each of the first holes H1 is larger than an injection amount from each of the second holes H2. Therefore, the part of the first coil end 22e1 having a higher coil density (part closer to the first end face 21e1) can be appropriately cooled.

A sufficient cooling effect may not be achieved in a part of the first coil end 22e1 that is located below the horizontal plane HP passing the center axis CA. This may occur, for example, when the cooling oil injected from a hole located below the horizontal plane HP has a larger injection velocity component in the opposite direction to the gravity direction as compared to the cooling oil injected from a hole located above the horizontal plane HP and/or when the temperature of the cooling oil injected from a hole located below the horizontal plane HP is higher than the temperature of the cooling oil injected from a hole located above the horizontal plane HP. In the technology according to the present embodiment, the second holes H2 are disposed only in the first section SE1 located below the horizontal plane HP. Thus, the part of the first coil end 22e1 that is located below the horizontal plane HP can be intensively cooled by the cooling oil injected through the second holes H2.

The first coil end 22e1 may require more cooling than the second coil end 22e2. This is, for example, because the first coil end 22e1 includes the welded portions 22w. In the technology according to the present embodiment, the first holes H1 and the second holes H2 are defined in the first annular member 41 which faces the first coil end 22e1, while only the third holes H3 are defined in the second annular member 42 which faces the second coil end 22e2. Thus, the vicinity of the welded portions 22w in the first coil end 22e1 can be appropriately cooled by the cooling oil injected from the first holes H1 and the second holes H2. The first coil end 22e1 including the welded portions 22w can be more intensively cooled than the second coil end 22e2. Appropriate cooling can be achieved even in a case where the coil ends have different configurations.

### Second Embodiment

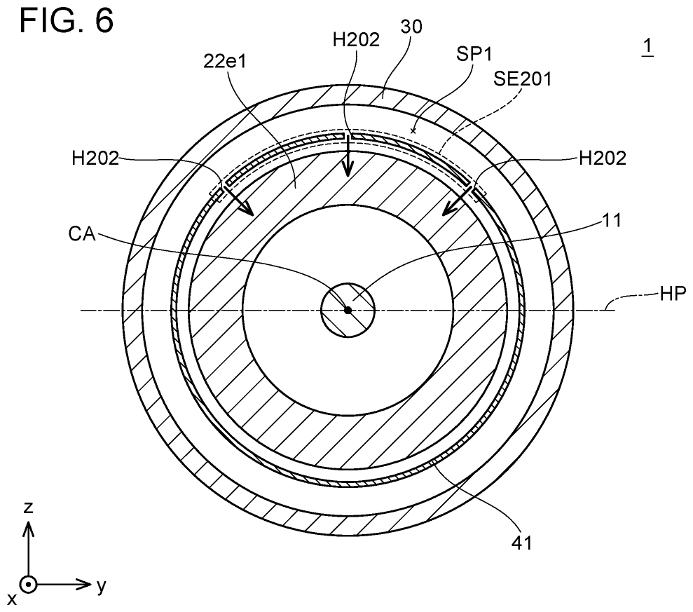

A second embodiment is different from the first embodiment in the position of a plurality of second holes H202. Configurations same as those described in connection with the first embodiment are labeled with the same reference signs, and description for them is omitted. Configurations unique to the second embodiment are labeled with reference signs having numbers of 200 or greater, for a distinction purpose. FIG. 6 shows a schematic cross-sectional view of a motor 1 according to the second embodiment. FIG. 6 shows a cross sectional view taken in the same manner as the cross-sectional view in FIG. 3B of the first embodiment.

The plurality of second holes H202 is disposed only in a first section SE201 of the circumference of the first annular member 41. The first section SE201 is located above the horizontal plane HP. In the present embodiment, three second holes H202 are disposed in the first section SE201.

### Effects

A sufficient cooling effect may not be achieved in a part of the first coil end 22e1 that is located above the horizontal plane HP. This may occur, for example, when the temperature of the cooling oil injected from a hole located above the horizontal plane HP is higher than the temperature of the cooling oil injected from a hole located below the horizontal plane HP. In the technology according to the present embodiment, the second holes H202 are disposed only in the first section SE201 located above the horizontal plane HP. Thus, the part of the first coil end 22e1 located above the horizontal plane HP can be appropriately cooled.

The cooling oil injected from above the horizontal plane HP falls by gravity to below the horizontal plane HP. That is, the cooling oil injected from above the horizontal plane HP contacts the coil end for a longer time than the cooling oil injected from below the horizontal plane HP. In the technology according to the present embodiment, an amount of the cooling oil injected from above the horizontal plane HP is larger than an amount of the cooling oil injected from below the horizontal plane HP. Thus, the cooling effect can be enhanced.

### Third Embodiment

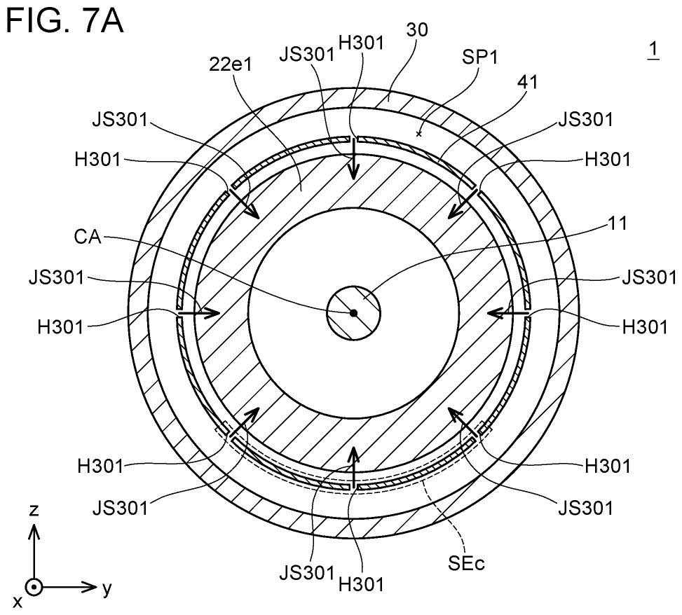

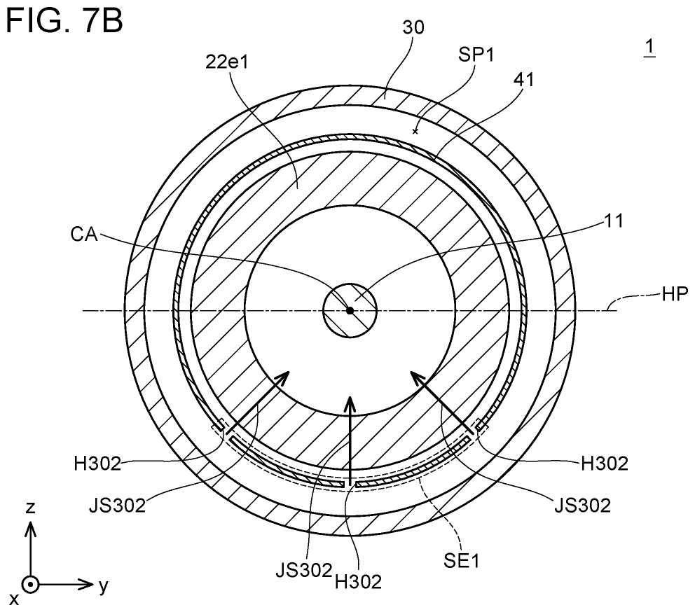

A third embodiment is different from the first embodiment in opening areas of a plurality of first holes H301 and a plurality of second holes H302. Configurations same as those described in connection with the first embodiment are labeled with the same reference signs, and description for them is omitted. Configurations unique to the third embodiment are labeled with reference signs having numbers of 300 or greater, for a distinction purpose. FIGS. 7A and 7B show schematic cross-sectional views of a motor 1 according to the third embodiment. FIGS. 7A and 7B each show a cross sectional view taken in the same manner as the cross-sectional view in FIGS. 3A and 3B of the first embodiment.

The first holes H301 all have the same first opening area. The second holes H302 all have the same second opening area. The first opening area is smaller than the second opening area. In FIG. 7A, an amount of the cooling oil injected from each first hole H301 is represented by a vector JS301. In FIG. 7B, an amount of the cooling oil injected from each second hole H302 is represented by a vector JS302. Longer vectors indicate larger amounts. The opening area of the first holes H301 is 90% or less of the opening area of the second holes H302. Thus, the vectors JS301 for the first holes H301 are significantly smaller than the vectors JS302 for the second holes H302.

### Effects

Cooling efficiency may be lower in a part of the first coil end 22e1 that is farther from the first end face 21e1 than in a part of the first coil end 22e1 that is closer to the first end face 21e1. This may occur, for example, when the coil 22 is indirectly cooled by cooling of the stator core 21. In the technology according to the present embodiment, an injection amount from each of the plurality of second holes H302 located farther from the first end face 21e1 is larger than an injection amount from each of the plurality of first holes H301 located closer to the first end face 21e1. Thus, the part of the first coil end 22e1 that is farther from the first end face 21e1 can be appropriately cooled.

### Fourth Embodiment

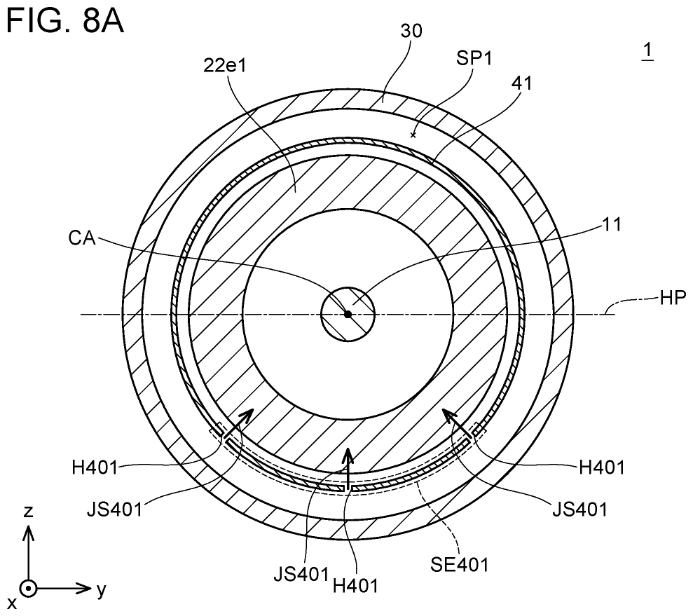

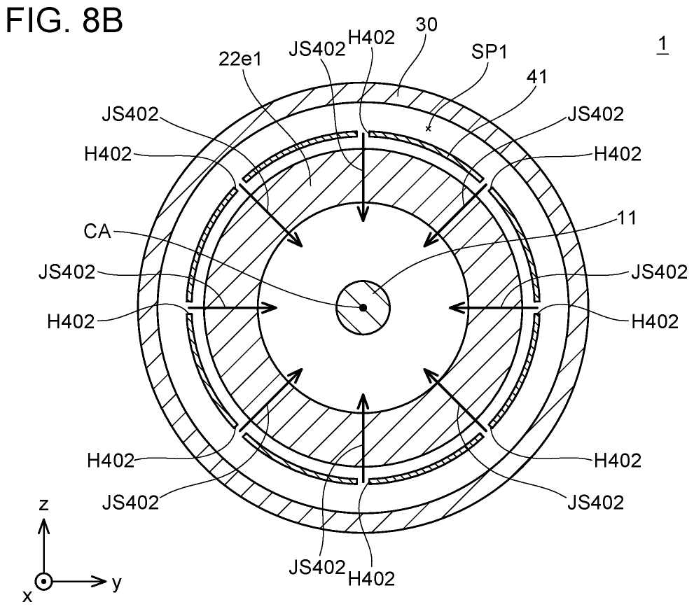

A fourth embodiment is different from the first embodiment in that the number of a plurality of first holes H401 and the number of a plurality of second holes H402. Configurations same as those described in connection with the first embodiment are labeled with the same reference signs, and description for them is omitted. Configurations unique to the fourth embodiment are labeled with reference signs having numbers of 400 or greater, for a distinction purpose. FIGS. 8A and 8B show schematic cross-sectional views of a motor 1 according to the fourth embodiment. FIGS. 8A and 8B each show a cross sectional view taken in the same manner as the cross-sectional view in FIGS. 3A and 3B of the first embodiment.

As shown in FIG. 8A, the plurality of first holes H401 is disposed only in a first section SE401. The first section SE401 is located below the horizontal plane HP. In the present embodiment, three first holes H401 are disposed in the first section SE401. Further, as shown in FIG. 8B, the second holes H402 are disposed over the entire circumference of the first annular member 41. The number of the second holes H402 (eight) is larger than the number of the first holes H401 (three).

A first opening area of the first holes H401 is 90% or less than a second opening area of the second holes H402. Thus, an amount of the cooling oil injected from the first holes H401 (vectors JS401) is significantly smaller than an amount of the cooling oil injected from the second holes H402 (vectors JS402).

### Effects

Cooling efficiency may be lower in a part of the first coil end 22e1 that is farther from the first end face 21e1 than in a part of the first coil end 22e1 that is closer to the first end face 21e1. In the technology according to the present embodiment, the total injection amount from the second holes H402 located farther from the first end face 21e1 is larger than the total injection amount from the first holes H401 located closer to the first end face 21e1. Thus, the part of the first coil end 22e1 that is farther from the first end face 21e1 can be appropriately cooled.

### Fifth Embodiment

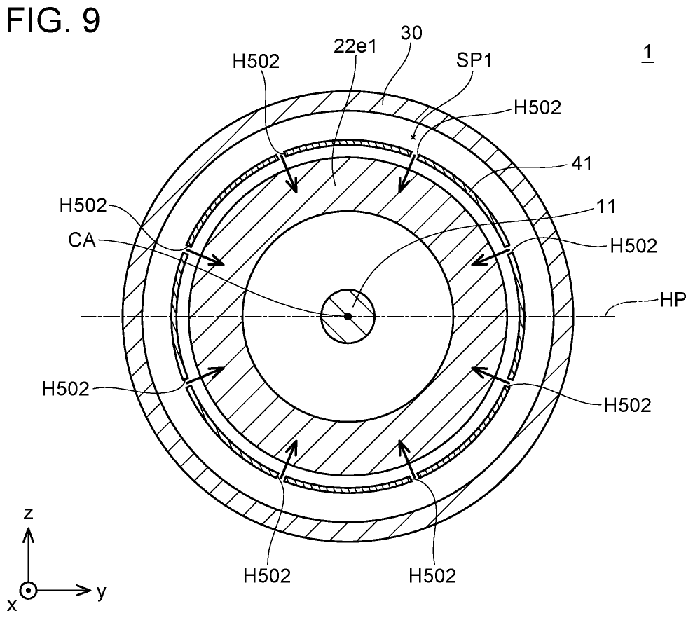

A fifth embodiment is different from the first embodiment in that the number of a plurality of second holes H502 and their positions in the circumferential direction. Configurations same as those described in connection with the first embodiment are labeled with the same reference signs, and description for them is omitted. Configurations unique to the fifth embodiment are labeled with reference signs having numbers of 500 or greater, for a distinction purpose. FIG. 9 shows a schematic cross-sectional view of a motor 1 according to the fifth embodiment. FIG. 9 shows a cross sectional view taken in the same manner as the cross-sectional view in FIG. 3B of the first embodiment.

As shown in FIG. 9, the second holes H502 are disposed over the entire circumference of the first annular member 41. Specifically, eight second holes H502 are equally spaced on the circumference. Each of the plurality of first holes H1 (see FIG. 3A) is located at a different position from any of the plurality of second holes H502 (see FIG. 9) in the circumferential direction of the first annular member 41. That is, the first holes H1 and the second holes H502 are alternately located in the circumferential direction of the first annular member 41.

### Effects

A region cooled by the cooling oil injected from each of the first holes H1 is less likely to overlap a region cooled by the cooling oil injected from each of the second holes H502. Thus, the first coil end 22e1 can be cooled evenly over a broad area.

### Sixth Embodiment

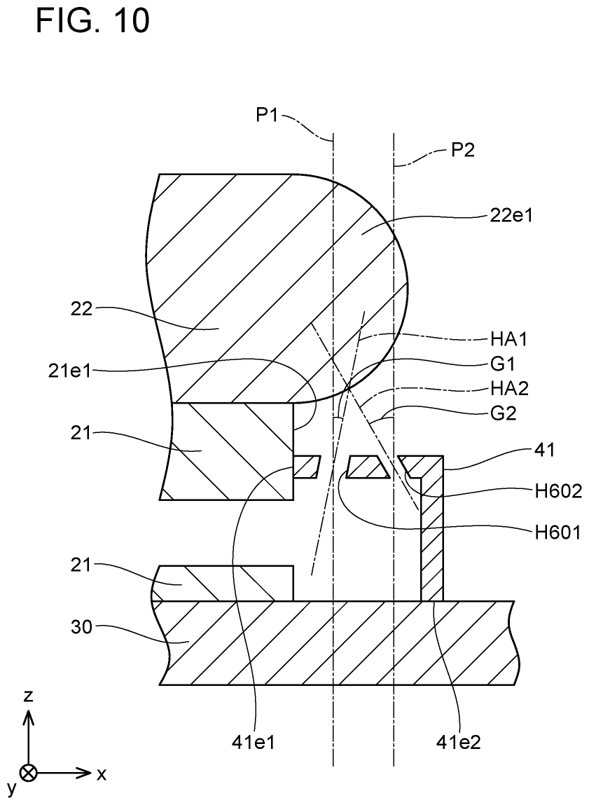

A sixth embodiment is different from the first embodiment in an angle of axes of a plurality of second holes H602. Configurations same as those described in connection with the first embodiment are labeled with the same reference signs, and description for them is omitted. Configurations unique to the sixth embodiment are labeled with reference signs having numbers of 600 or greater, for a distinction purpose. FIG. 10 shows a schematic cross-sectional view of a motor 1 according to the sixth embodiment. FIG. 10 shows an enlarged view of a region that is at the same position as the region R10 in FIG. 1 of the first embodiment.

A first hole H601 and a second hole H602 have a hole axis HA1 and a hole axis HA2, respectively. Directions of the hole axes HA1 and HA2 are coincident with the directions in which corresponding holes penetrate the first annular member 41 in its thickness direction. An angle between the hole axis HA1 and the first plane P1 is an angle G1. An angle between the hole axis HA2 and the second plane P2 is an angle G2. The angle G1 is different from the angle G2. Further, the hole axis HA2 is inclined toward the first plane P1. That is, when the hole axis HA2 is extended toward the center axis CA (in +z-direction), the hole axis HA2 intersects the first plane P1.

The cooling oil is injected from the first hole H601 along the hole axis HA1. Thus, the cooling oil is injected at the angle G1 relative to the first plane P1. The cooling oil is also injected from the second hole H602 along the hole axis HA2. Thus, the cooling oil is injected at the angle G2 relative to the second plane P2. Therefore, the injection direction of the cooling oil injected from the second hole H602 located farther from the first end face 21e1 is oriented toward the first end face 21e1. The first coil end 22e1 can thus be appropriately cooled. The above-described features of the hole axis HA1 are applied to hole axes of all the first holes H601. Further, the above-described features of the hole axis HA2 are applied to hole axes of all the second holes H602.

### Effects

The injection direction of cooling oil from the first holes H601 is different from the injection direction of cooling oil from the second holes H602. A region cooled by the cooling oil injected from the first holes H601 and a region cooled by the cooling oil injected from the second holes H602 can be set separately.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

### Modifications

The shape of the openings of the first and second holes is not limited to circle but may be various other shapes. Further, the number and arrangement of the first and second holes are not limited to those described herein but may be different.

The second annular member 42 may further comprise a plurality of fourth holes H4 located on a fourth plane P4. The fourth plane P4 is perpendicular to the center axis CA and is axially spaced apart from the third plane P3.

What is claimed is:

1. A motor comprising:
a rotor;
a stator comprising a stator core and a coil;
a housing that houses the rotor and the stator; and
a first annular member that provides a seal between a first end face of the stator core in an axial direction of the stator core and an inner wall surface of the housing,
wherein
the first annular member has a cylindrical shape about an axis of the stator core,
the first annular member comprises at least one first hole and at least one second hole through which refrigerant is injected toward a first coil end of the coil protruding from the first end face of the stator core,
the at least one first hole is located on a first plane perpendicular to the axis, and
the at least one second hole is located on a second plane that is perpendicular to the axis and spaced apart from the first plane in the axial direction.

2. The motor according to claim 1, wherein
a distance from the second plane to the first end face of the stator core is greater than a distance from the first plane to the first end face of the stator core, and
a number of the at least one first hole is greater than a number of the at least one second hole.

3. The motor according to claim 2, wherein the at least one first hole comprises a plurality of first holes disposed over an entirety of a circumference of the first annular member.

4. The motor according to claim 3, wherein the at least one second hole is disposed only in a first section of the circumference of the first annular member.

5. The motor according to claim 4, wherein the first section of the circumference of the first annular member is located below a horizontal plane passing through the axis.

6. The motor according to claim 4, wherein the first section of the circumference of the first annular member is located above a horizontal plane passing through the axis.

7. The motor according to claim 1, wherein
a distance from the second plane to the first end face of the stator core is greater than a distance from the first plane to the first end face of the stator core, and
a number of the at least one first hole is smaller than a number of the at least one second hole.

8. The motor according to claim 1, wherein
a distance from the second plane to the first end face of the stator core is greater than a distance from the first plane to the first end face of the stator core, and
an opening area of the at least one first hole is larger than an opening area of the at least one second hole.

9. The motor according to claim 1, wherein
a distance from the second plane to the first end face of the stator core is greater than a distance from the first plane to the first end face of the stator core, and
an opening area of the at least one first hole is smaller than an opening area of the at least one second hole.

10. The motor according to claim 1, wherein each of the at least one first hole is located at a different position from any of the at least one second hole in a circumferential direction of the first annular member.

11. The motor according to claim 10, wherein
the at least one first hole comprises a plurality of first holes,
the at least one second hole comprises a plurality of second holes, and
the first holes and the second holes are arranged alternately along the circumferential direction of the first annular member.

12. The motor according to claim 1, wherein each of the at least one second hole is aligned with a corresponding one of the at least one first hole in a circumferential direction of the first annular member.

13. The motor according to claim 1, wherein an angle between an axis of each of the at least one second hole and the second plane is different from an angle between an axis of each of the at least one first hole and the first plane.

14. The motor according to claim 1, wherein
a distance from the second plane to the first end face of the stator core is greater than a distance from the first plane to the first end face of the stator core, and
an axis of each of the at least one second hole is inclined toward the first plane.

15. The motor according to claim 1, wherein
the coil comprises a plurality of segment coils, outer surfaces of the segment coils being coated with insulating films,
at the first coil end, ends of the plurality of segment coils are each exposed from the insulating films, and
each pair of segment coils comprises a welded portion where the ends of the segment coils are welded to each other.

16. The motor according to claim 1, wherein
the motor further comprises a second annular member that provides a seal between a second end face of the stator core and the inner wall surface of the housing, the second end face being opposite to the first end face of the stator core in the axial direction,
the second annular member has a cylindrical shape about the axis of the stator core,
the second annular member comprises at least one third hole through which the refrigerant is injected toward a second coil end of the coil protruding from the second end face of the stator core, and
each of the at least one third hole is located on a third plane perpendicular to the axis.
